(19) United States
(12) Patent Application Publication
(10) Pub. No.: US 2011/0243447 A1
(43) Pub. Date: Oct. 6, 2011

(54) METHOD AND APPARATUS FOR SYNTHESIZING SPEECH

(75) Inventor: Franciscus Johannes Henricus Maria Meulenbroeks, Eindhoven (NL)

(73) Assignee: KONINKLIJKE PHILIPS ELECTRONICS N.V., EINDHOVEN (NL)

(21) Appl. No.: 13/133,301

(22) PCT Filed: Dec. 7, 2009
(86) PCT No.: PCT/IB09/55534

§ 371 Date: Jun. 7, 2011

(30) Foreign Application Priority Data
Dec. 15, 2008 (EP) 08171611.0

(51) Int. Cl. G10L 13/00; G06K 9/18

(52) U.S. Cl. 382/182; 704/260; 704/E13.001

(57) ABSTRACT

Method and apparatus of synthesizing speech from a plurality of portion of text data, each portion having at least one associated attribute. The invention is achieved by determining (25, 35, 45) a value of the attribute for each of the portions of text data, selecting (27, 37, 47) a voice from a plurality of candidate voices on the basis of each of said determined attribute values, and converting (29, 39, 49) each portion of text data into synthesized speech using said respective selected voice.

### FIELD OF THE INVENTION

The present invention relates to a method and apparatus for synthesizing speech, and in particular, synthesizing speech from a plurality of portions of text data.

### BACKGROUND OF THE INVENTION

Speech synthesis, and in particular text-to-speech conversion, is well known in the art and comprises the artificial production of human speech from, for instance, source text. In this way, text is converted into speech, which is useful for the illiterate or poor of sight. In combination with machine translation of source text, text-to-speech conversion may also allow for audio reproduction of foreign language text in the native language of a user.

One form of text that may be converted to speech is subtitles. Subtitles are text portions that are displayed during playback of a video item such as a television program or a film. Subtitles come in three main types, widely known to those skilled in the art: ‘open’ subtitles, where subtitle text is merged with video frames from an original video stream to produce a final video stream for subsequent display in a conventional manner; ‘prerendered’ subtitles, where the subtitles are stored as separate video frames which may be optionally overlaid on an original video stream for viewing together; and ‘closed’ subtitles, where the subtitle text is stored as marked-up text (i.e. text with marked-up annotations such as in XML or HTML), and is reproduced by a dedicated system that enables synchronous playback with an original video stream, for instance Teletext subtitles or closed captioning information.

It is known for various symbols and styles to be applied to subtitle text to convey additional information to viewers, such as whether a portion of text is being spoken or sung, or whether a portion of text refers to a sound other than speech (e.g. a door slamming, or a sigh). In addition, it is known for subtitles to be reproduced in a variety of colours, each colour representing a given speaker or group of speakers. Thus, the hard of hearing may distinguish between speakers during a television broadcast by associating a colour with each speaker.

Subtitles are also used for the purpose of translation. For instance, a film containing speech in a first language may have subtitles in a second language applied thereto, thereby allowing readers of the second language to appreciate the film. However, this solution is insufficient for those speakers of the second language who have difficulty reading (e.g. due to poor sight or illiteracy). One option widely used by filmmakers is to employ actors to ‘dub’ over the original speech, but this is an expensive and time consuming process.

None of the present arrangements allow a user that has difficulty reading to distinguish between different categories of information presented in a textual form.

### SUMMARY OF THE INVENTION

The present invention intends to enable a user to distinguish between different categories of text by providing speech synthesis in a respective voice for each category or group of categories of text.

According to a first aspect of the present invention, there is provided a method of synthesizing speech, comprising: receiving a plurality of portions of text data, each portion of text data having at least one attribute associated therewith; determining a value of at least one attribute for each of the portions of text data; selecting a voice from a plurality of candidate voices, on the basis of each of said determined attribute values; and converting each portion of text data into synthesized speech using said respective selected voice.

In this way, it is possible for different categories of text (for instance, relating to different speakers, or to different categories of information content such as titles and headings of sections versus section content) to be distinguished from each other.

The plurality of portions of text data may be contained within closed subtitles (e.g. as marked-up text data). Furthermore, determining a value of at least one attribute for each of the portions of text data may comprise, for each of the portions of text data, determining a code contained within the closed subtitles associated with a respective portion of the text data (for instance, by identifying annotations to the marked-up text data).

Alternatively, receiving a plurality of portions of text data may comprise performing optical character recognition (OCR) or a similar pattern matching technique on a plurality of images (e.g. frames of a video) each containing at least one visual representation of a text portion comprising closed subtitles, prerendered subtitles, or open subtitles to provide a plurality of portions of text data. Furthermore, the at least one attribute of one of the plurality of portions of text data may comprise: a text characteristic (e.g. colour, typeface, font, font weight, size or width, font style, such as italics or bold, etc.) of one of the visual representations of a text portion; a location of one of the visual representations of a text portion in the image (e.g. to the left or right, or top or bottom, of a video frame, or adjacent another text portion in the image); or a pitch of an audio signal for simultaneous reproduction with one of the visual representations of a text portion in the respective image (e.g. the pitch of a speaker's voice in a first language, of which the text portion is a translation into a second language).

The candidate voices may include male and female voices, voices having different accents and/or voices that differ in their respective pitches or volumes.

Selecting a voice may comprise selecting a best (i.e. a most appropriate) voice from the plurality of candidate voices. For instance, if an attribute associated with a portion of text data indicates that the text is in capitals, speech may be synthesized at a higher volume, or with a more urgent sounding voice. Similarly, if an attribute is in the form of a term (such as ‘[whispering]’) preceding a portion of text, speech may be synthesized at a lower volume. On the other hand, if an attribute associated with a portion of text corresponds to the volume or pitch of an audio signal for simultaneous reproduction, the voice may be chosen such that the volume or pitch of the synthesized speech corresponds. Alternatively, selection of an appropriate voice could be made by a user, instead of, or to override, automatic selection.

According to a second aspect of the present invention, there is provided a computer program product comprising a plurality of program code portions for carrying out the above method.

According to a third aspect of the present invention, there is provided an apparatus for synthesizing speech from a plurality of portions of text data, each portion of text data having at least one attribute associated therewith, comprising: a value determination unit, for determining a value of at least one attribute for each of a plurality of portions of text data; a voice selection unit, for selecting a voice from a plurality of candidate voices, on the basis of each of said determined attribute values; and a text-to-speech converter, for converting each portion of text data into synthesized speech using said respective selected voice.

The value determination unit may comprise code determining means for determining a code associated with a respective portion of the text data and contained within closed subtitles, for each of the portions of text data.

Alternatively, the apparatus may further comprise a text data extraction unit for performing optical character recognition (OCR) or a similar pattern matching technique on a plurality of images each containing at least one visual representation of a text portion comprising closed subtitles, prerendered subtitles, or open subtitles to provide the plurality of portions of text data. Furthermore, the at least one attribute of one of the plurality of portions of text data may comprise: a text characteristic (e.g. colour, typeface, font, font weight, size or width, font style, such as italics or bold, etc.) of one of the visual representations of a text portion; a location of one of the visual representations of a text portion in the image; or a pitch of an audio signal for simultaneous reproduction with one of the visual representations of a text portion in the respective image.

### BRIEF DESCRIPTION OF THE DRAWINGS

For a better understanding of the present invention, and to show more clearly how it may be carried into effect, reference will now be made, by way of example, to the following drawings, in which:

FIG. 1a shows an apparatus according to a first embodiment of the present invention.

FIG. 1b shows an apparatus according to a second embodiment of the present invention.

FIG. 1c shows an apparatus according to a third embodiment of the present invention.

FIG. 2 shows an apparatus according to a fourth embodiment of the present invention.

FIG. 3a is a flow chart describing a method according to a fifth embodiment of the present invention.

FIG. 3b is a flow chart describing a method according to a sixth embodiment of the present invention.

FIG. 3c is a flow chart describing a method according to a seventh embodiment of the present invention.

### DETAILED DESCRIPTION OF EMBODIMENTS OF THE INVENTION

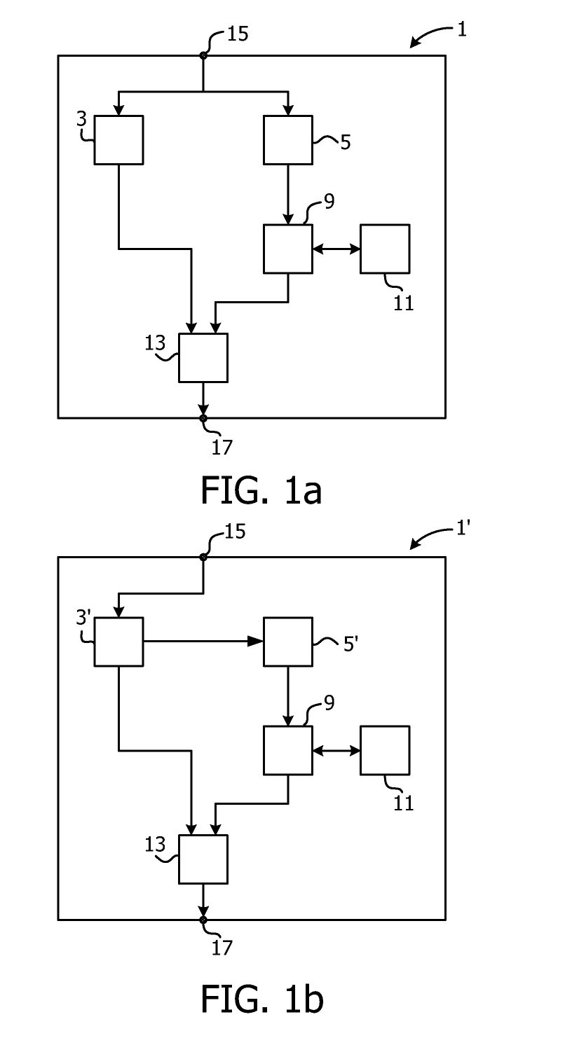

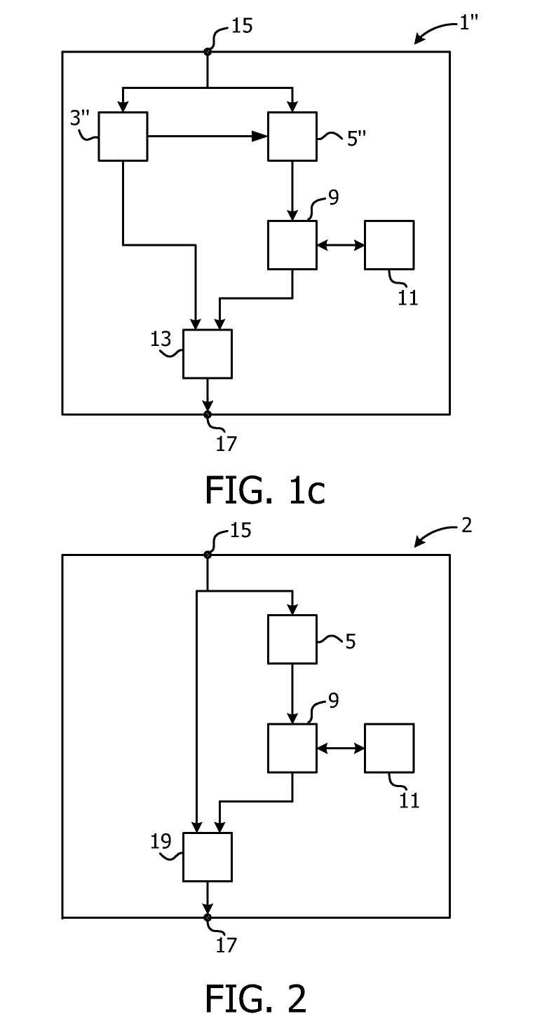

Referring to FIG. 1a, an apparatus 1, according to an embodiment of the present invention, comprises a text data extraction unit 3, a value determination unit 5, a voice selection unit 9, a memory unit 11, and a text-to-speech converter 13.

An input terminal 15 of the apparatus 1 is connected to an input of the text data extraction unit 3 and an input of the value determination unit 5. An output of the value determination unit 5 is connected to an input of the voice selection unit 9. The voice selection unit 9 and the memory unit 11 are operably coupled to each other. Outputs of the text data extraction unit 3 and the voice selection unit 9 are connected to inputs of the text-to-speech converter 13. An output of the text-to-speech converter 13 is connected to an output terminal 17 of apparatus 1.

In operation, the text data extraction unit 3 receives data via the input terminal 15. The text data extraction unit 3 is configured to process the received data to extract a portion of text, which is then passed to the text-to-speech converter 13. For instance, if the data is an audio-visual or video stream (from which an image containing a visual representation of a text portion is taken), or simply an image containing a visual representation of a text portion, the text data extraction unit 3 is configured to perform optical character recognition on the image to extract a portion of text, which is then passed to the text-to-speech converter 13. Alternatively or additionally, if the data is in the form of text marked-up with annotations, the text extraction unit 3 is configured to extract the text from the annotated (marked-up) text, and then pass this portion of text to the text-to-speech converter 13.

The value determination unit 5 is also configured to receive directly the data via the input terminal 15. The value determination unit 5 is configured to determine a value of at least one attribute of the extracted portion of text, based on the data from the input terminal 15. For instance, if the data is an audio-visual or video stream (from which an image containing a visual representation of a text portion is taken), or simply an image containing a visual representation of a text portion, the value determination unit 5 is configured to identify a text characteristic in the image, and assign a value to that text characteristic. If the data is an audio-visual stream, the value determination unit 5 is configured to identify a pitch of an audio component of the audio-visual stream, and select a value associated with the pitch. If the data is in the form of text marked-up with annotations, the value determination unit 5 is configured to identify a particular annotation, and assign a value to that annotation. This value is then transmitted to voice selection unit 9.

The voice selection unit 9 selects a voice from a plurality of candidate voices stored in memory unit 11, on the basis of the value. The text-to-speech converter 13 employs standard techniques to convert the portion of text delivered to it by the text data extraction unit 3 into speech, using the selected voice, which is then output at the output terminal 17.

FIG. 1b shows an apparatus 1′, according to an embodiment of the present invention that is similar to the apparatus 1 of FIG. 1a. The apparatus 1′ has a text data extraction unit 3′, a value determination unit 5′, a voice selection unit 9, a memory unit 11, and a text-to-speech converter 13.

An input terminal 15 of the apparatus 1′ is connected to an input of the text data extraction unit 3′. One output of the text data extraction unit 3′ is connected to an input of the value determination unit 5′. An output of the value determination unit 5′ is connected to an input of the voice selection unit 9. The voice selection unit 9 and the memory unit 11 are operably coupled to each other. A second output of the text data extraction unit 3′ and an output of the voice selection unit 9 are connected to inputs of the text-to-speech converter 13. An output of the text-to-speech converter 13 is connected to an output terminal 17 of apparatus 1′.

In operation, the text data extraction unit 3′ receives data via the input terminal 15. The text data extraction unit 3′ is configured to process the received data to extract a portion of text, which is then passed to the text-to-speech converter 13. The text data extraction unit 3′ is also configured to identify an attribute associated with the portion of text, which is then passed to the value determination unit 5′. For instance, if the data is an audio-visual or video stream (from which an image containing a visual representation of a text portion is taken), or simply an image containing a visual representation of a text portion, the text data extraction unit 3′ is configured to perform optical character recognition on the image to extract a portion of text, which is then passed to the text-to-speech converter 13. The text data extraction unit 3′ is additionally configured to identify an attribute associated with the text obtained via optical character recognition, such as a text characteristic of the text in the image, the location of the text in the image, or an audio component of the audio-visual stream that accompanies the image, and then pass this attribute to the value determination unit 5′.

Alternatively or additionally, if the data is in the form of text marked-up with annotations, the text extraction unit 3′ is configured to extract the text from the annotated (marked-up) text, and then pass this portion of text to the text-to-speech converter 13. The text data extraction unit 3′ is additionally configured to identify an annotation associated with the text obtained via extraction and then pass this annotation to the value determination unit 5′.

The value determination unit 5′ is configured to determine a value of the attribute passed to it by the text extraction unit 3′.

The voice selection unit 9 selects a voice from a plurality of candidate voices stored in memory unit 11, on the basis of the value. The text-to-speech converter 13 uses this voice to convert the portion of text delivered to it by the text data extraction unit 3 into speech, which is then output at the output terminal 17.

Various modifications to and combinations of the above two embodiments are envisaged. For instance, FIG. 1c shows an apparatus 1″ according to an embodiment of the present invention comprising a text data extraction unit 3″, a value determination unit 5″, a voice selection unit 9, a memory unit 11, and a text-to-speech converter 13.

An input terminal 15 of the apparatus 1″ is connected to an input of the text data extraction unit 3″ and one input of the value determination unit 5″. One output of the text data extraction unit 3″ is connected to a second input of the value determination unit 5″. An output of the value determination unit 5″ is connected to an input of the voice selection unit 9. The voice selection unit 9 and the memory unit 11 are operably coupled to each other. A second output of the text data extraction unit 3″ and an output of the voice selection unit 9 are connected to inputs of the text-to-speech converter 13. An output of the text-to-speech converter 13 is connected to an output terminal 17 of apparatus 1″.

In this embodiment, the text data extraction unit 3″ and the value determination unit 5″ are configured to behave as either of the arrangements of FIG. 1a or 1b, depending on a user preference or the form of the data received via input 15.

FIG. 2 shows a further alternative embodiment of the invention in the form of an apparatus 2 that has a value determination unit 5, a voice selection unit 9, a memory unit 11, and a text-to-speech converter 19.

An input terminal 15 of the apparatus 2 is connected to a first input of the text-to-speech converter 19 and an input of the value determination unit 5. An output of the value determination unit 5 is connected to an input of the voice selection unit 9. The voice selection unit 9 and the memory unit 11 are operably coupled to each other. An output of the voice selection unit 9 is connected to a second input of the text-to-speech converter 19. An output of the text-to-speech converter 19 is connected to an output terminal 17 of apparatus 2.

In operation, the text-to-speech converter 19 is configured to interpret directly the data received via input 15, thus obviating the need for a text extraction unit.

Although not shown in the figures, various embodiments of the present invention additionally include a user interface device for user interaction with the apparatus. Such interaction may include manipulating the voice selection unit 9 to select a best (i.e. a most appropriate) voice from the plurality of candidate voices stored in memory unit 11, for a given output of the value determination unit. Alternatively, selection of a best voice may be achieved automatically by the voice selection unit, based on the output of the value determination unit.

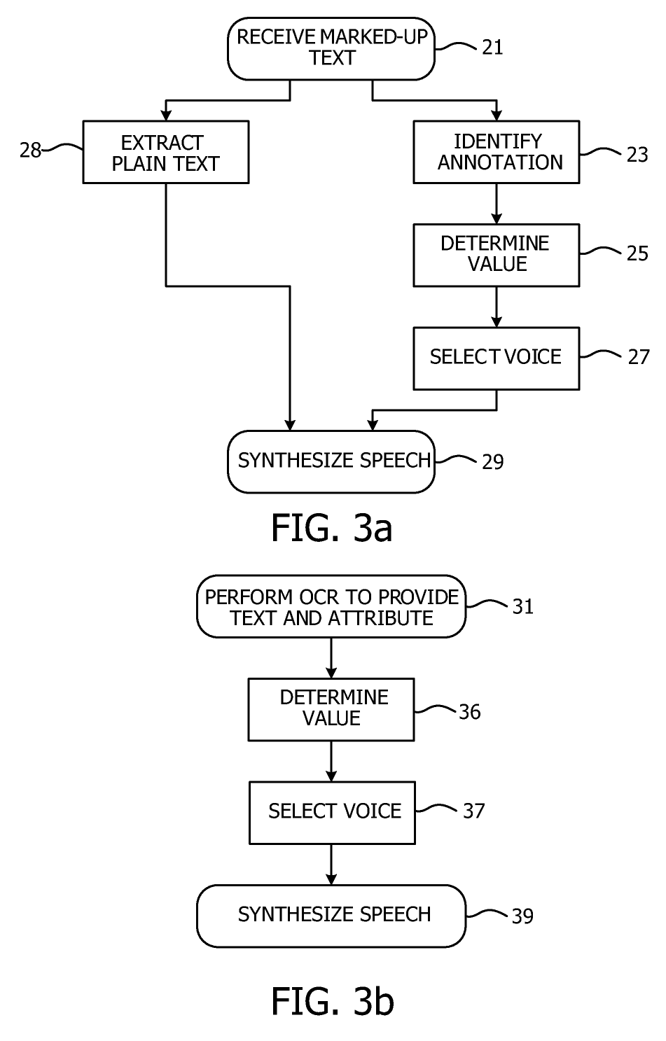

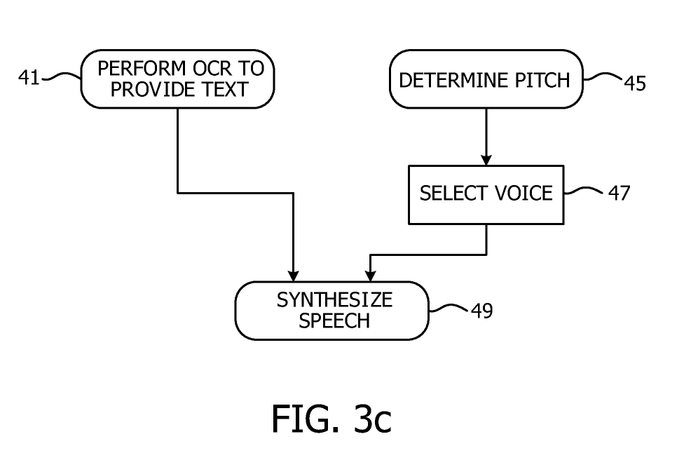

One exemplary method of synthesizing speech according to an embodiment of the present invention is shown in the flow chart of FIG. 3a. At 21, a portion of text marked-up with annotations is received. At 23, an annotation associated with the portion of marked-up text is identified. At 25, a value of the annotation is determined. At 27, a voice from a plurality of candidate voices is selected, on the basis of the value. At 28, plain text is extracted from the portion of marked-up text, to produce a portion of plain text. At 29, the portion of plain text is converted into synthesized speech using the selected voice. The above steps are then repeated for a new portion of marked-up text having an annotation of a different value associated with it.

Another exemplary method of synthesizing speech according to an embodiment of the present invention is shown in FIG. 3b. At 31, optical character recognition is performed on a frame of a video, to provide a portion of text data and an associated attribute. At 36, a value of the attribute is determined. At 37, a voice from a plurality of candidate voices is selected, on the basis of the value. At 39, the portion of text data is converted into synthesized speech using the selected voice. The above steps are then repeated for a new video frame.

A further exemplary method of synthesizing speech according to an embodiment of the present invention is shown in FIG. 3c. At 41, optical character recognition is performed on an image of a video component of an audio-visual stream, to provide a portion of text data. At 45, a respective pitch of an audio component of an audio-visual stream, for simultaneous reproduction with the frame, is determined. At 47, a voice from a plurality of candidate voices is selected, on the basis of the determined pitch. At 49, the portion of text data is converted into synthesized speech using the selected voice. The above steps are then repeated for a new image and associated audio component.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of synthesizing speech, comprising:
receiving a plurality of portions of text data (21, 31, 41), each portion of text data having at least one attribute associated therewith;
determining (25, 35, 45) a value of at least one attribute for each of the portions of text data;
selecting (27, 37, 47) a voice from a plurality of candidate voices, on the basis of each of said determined attribute values; and
converting (29, 39, 49) each portion of text data into synthesized speech using said respective selected voice.

2. The method of claim 1, wherein receiving (21, 31, 41) a plurality of portions of text data comprises receiving (21) closed subtitles that contain a plurality of portions of text data.

3. The method of claim 2, wherein determining (25, 35, 45) a value of at least one attribute for each of the portions of text data comprises, for each of the portions of text data, determining (25) a code contained within the closed subtitles associated with a respective portion of the text data.

4. The method of claim 1, wherein receiving (21, 31, 41) a plurality of portions of text data comprises performing (31, 41) optical character recognition (OCR) or a similar pattern matching technique on a plurality of images each containing at least one visual representation of a text portion comprising closed subtitles, prerendered subtitles, or open subtitles to provide a plurality of portions of text data.

5. The method of claim 4, wherein the at least one attribute of one of the plurality of portions of text data comprises:
a text characteristic of one of the visual representations of a text portion;
a location of one of the visual representations of a text portion in the image; or
a pitch of an audio signal for simultaneous reproduction with one of the visual representations of a text portion in the respective image.

6. The method of claim 1, wherein the candidate voices include male and female voices and/or voices that differ in their respective volumes.

7. The method of claim 1, wherein selecting a voice comprises selecting a best voice from the plurality of candidate voices.

8. A computer program product comprising a plurality of program code portions for carrying out the method according to claim 1.

9. Apparatus (1, 1′, 1″, 2) for synthesizing speech from a plurality of portions of text data, each portion of text data having at least one attribute associated therewith, comprising:
a value determination unit (5, 5′, 5″), for determining a value of at least one attribute for each of a plurality of portions of text data;
a voice selection unit (9), for selecting a voice from a plurality of candidate voices, on the basis of each of said determined attribute values; and
a text-to-speech converter (13, 19), for converting each portion of text data into synthesized speech using said respective selected voice.

10. The apparatus (1, 1′, 1″, 2) of claim 9, wherein the value determination unit (5, 5′, 5″) comprises code determining means for determining a code associated with a respective portion of the text data and contained within closed subtitles, for each of the portions of text data.

11. The apparatus (1, 1′, 1″, 2) of claim 9, further comprising a text data extraction unit (3, 3′, 3″) for performing optical character recognition (OCR) or a similar pattern matching technique on a plurality of images each containing at least one visual representation of a text portion comprising closed subtitles, prerendered subtitles, or open subtitles to provide the plurality of portions of text data.

12. The apparatus (1, 1′, 1″, 2) of claim 11, wherein the at least one attribute of one of the plurality of portions of text data comprises:
a text characteristic of one of the visual representations of a text portion;
a location of one of the visual representations of a text portion in the image; or a pitch of an audio signal for simultaneous reproduction with one of the visual representations of a text portion in the respective image.

13. The apparatus (1, 1′, 1″, 2) of claim 9, wherein the candidate voices include male and female voices and/or voices that differ in their respective volumes.

14. The apparatus (1, 1′, 1″, 2) of claim 9, wherein the voice selection unit (9) is for selecting a best voice from a plurality of candidate voices, on the basis of each of said determined attribute values.

15. An audio visual display device including the apparatus (1, 1′, 1″, 2) of claim 9.
